(19) United States
(12) Patent Application Publication
(10) Pub. No.: US 2012/0098827 A1
(43) Pub. Date: Apr. 26, 2012

(54) THREE-DIMENSIONAL IMAGE DISPLAY APPARATUS

(75) Inventors: Kazunari Yoshifuji, Tokyo (JP); Isao Ohashi, Kanagawa (JP)

(73) Assignee: SONY CORPORATION, Tokyo (JP)

(21) Appl. No.: 13/269,077

(22) Filed: Oct. 7, 2011

(30) Foreign Application Priority Data
Oct. 26, 2010 (JP) 2010-239712

(51) Int. Cl. G06T 15/00

(52) U.S. Cl. 345/419

(57) ABSTRACT

An image display apparatus includes: an image display device having a two-dimensional array of pixels each formed by a plurality of sub-pixels and displaying a plurality of view point images in a composite manner by allocating the images to the sub-pixels; and a parallax device spatially separating the view point images displayed on the image display device, wherein the image display device displays each view point image using a first combination format and a second combination format as formats for combining a plurality of sub-pixels for forming each pixel, the combination formats having shapes which are the inverse of each other when viewed in the vertical direction, the image being displayed such that a first pixel arrangement pattern formed using the first combination format and a second pixel arrangement pattern formed using the second combination format alternately appear in the vertical direction.

### CROSS REFERENCES TO RELATED APPLICATIONS

The present application claims priority to Japanese Priority Patent Application JP 2010-239712 filed in the Japan Patent Office on Oct. 26, 2010, the entire content of which is hereby incorporated by reference.

### BACKGROUND

The present application relates to a three-dimensional image display apparatus which displays three-dimensional images utilizing a parallax device.

Three-dimensional display techniques may be categorized into techniques involving eyeglasses to be used by a viewer and techniques allowing a viewer to enjoy a three-dimensional view of an image without eyeglasses. The latter method of display may be referred to as an unaided-eye three-dimensional display method. The unaided-eye three-dimensional display method is typically implemented using a parallax barrier or a lenticular lens. According to the approach involving a parallax barrier or a lenticular lens, a plurality of spatially partitioned parallax images to produce a three-dimensional view are compositely displayed on an image display device such as a liquid crystal display (view point images for a plurality of view points, e.g., images for a right eye and images for a left eye or images for two view points, are displayed). The parallax images (view point images) are separated from each other in the horizontal direction because of parallax provided by parallax separation means (parallax device) and are consequently viewed as a three-dimensional image. According to the parallax barrier approach, a parallax barrier having slit-like openings may be used as the parallax device. According to the lenticular lens approach, a lenticular lens obtained by disposing a plurality of cylindrical separation lenses side by side may be used as the parallax device.

Japanese Patent No. 3955002 (Patent Document 1) and JP-A-2010-44181 (Patent Document 2) disclose the related art.

### SUMMARY

A three-dimensional image display apparatus employing an image display device and a parallax device as described above has a problem in that the resolution of each view point image can become lower than the inherent display resolution of the image display device because a plurality of view point images are spatially partitioned when they are displayed in one screen. For example, let us assume that a three-dimensional image obtained from two view points is displayed according to the parallax barrier approach. When the openings of the parallax barrier are patterned (barrier pattern) like vertical stripes to display view point images for the two view points such that they alternate in the horizontally direction, the resolution of each of the view point images becomes one half of the inherent resolution. One known method of suppressing degradation of horizontal resolution as thus described is to use a barrier pattern in the form of oblique stripes or oblique steps to display view point images as patterns in the form of oblique stripes (see Patent Documents 1 and 2). The use of a barrier pattern in the form of oblique stripes or oblique steps as thus described allows degradation of resolution in the horizontal direction to be more effectively suppressed compared to degradation that occurs when a barrier pattern in the form of vertical stripes is used. However, resolution is degraded in the vertical direction. FIG. 6 of Patent Document 2 illustrates a technique for displaying one pixel of each view point image as a triangular pattern constituted by a combination of sub-pixels arranged in the horizontal direction and sub-pixels arranged in the vertical direction. According to the technique, however, pixels are arranged in such a pattern that a plurality of triangular pixels identical to each other are consecutively aligned in the vertical direction. As a result, the technique results in significant degradation of resolution in the vertical direction.

It is therefore desirable to provide an image display apparatus capable of displaying three-dimensional images having resolution higher than that achievable in the related art.

An embodiment is directed to an image display apparatus including an image display device having a two-dimensional array of pixels each formed by a plurality of sub-pixels and displaying a plurality of view point images in a composite manner by allocating the images to the sub-pixels and a parallax device spatially separating the view point images displayed on the image display device.

The image display device displays each view point image using a first combination format and a second combination format as formats for combining a plurality of sub-pixels for forming each pixel, the combination formats having shapes which are the inverse of each other when viewed in the vertical direction. The image is displayed such that a first pixel arrangement pattern formed using the first combination format and a second pixel arrangement pattern formed using the second combination format alternately appear in the vertical direction.

In the image display apparatus according to the embodiment, each view point image is displayed by using the first combination format and the second combination format having shapes which are the inverse of each other when viewed in the vertical direction such that the first pixel arrangement pattern formed using the first combination format and the second pixel arrangement pattern formed using the second combination format alternately appear in the vertical direction.

In the image display apparatus according to the embodiment, each view point image is displayed by using the first combination format and the second combination format having shapes which are the inverse of each other when viewed in the vertical direction such that the first pixel arrangement pattern and the second pixel arrangement pattern formed using those combination formats alternately appear in the vertical direction. Therefore, a three-dimensional image can be displayed at resolution higher than that in the related art. In particular, the embodiment allows degradation of resolution in the vertical direction to be more effectively suppressed compared to a method according to the related art employing a barrier pattern in the form of oblique stripes or oblique steps.

Additional features and advantages are described herein, and will be apparent from the following Detailed Description and the figures.

### BRIEF DESCRIPTION OF THE FIGURES

FIG. 1 is a perspective view of a three-dimensional image display apparatus according to a first embodiment showing an exemplary generation configuration thereof;

FIG. 2 is a plan view of an image display device of the three-dimensional image display apparatus shown in FIG. 1 showing a pixel configuration thereof;

FIG. 3 is a plan view of parallax barrier of the three-dimensional image display apparatus shown in FIG. 1 showing a configuration thereof;

FIG. 4A is a plan view of the display device shown in FIG. 1 showing an arrangement of four pixels thereof. FIG. 4B is a plan view of an exemplary pixel arrangement pattern for displaying a three-dimensional image on the three-dimensional image display apparatus in the case of two view points, the illustration showing a four pixels worth of area to be viewed from each view point.

FIG. 5A is a plan view of pixels viewed from a first view point when a three-dimensional image is to be displayed for two view points by the three-dimensional image display apparatus shown in FIG. 1;

FIG. 5B is a plan view of pixels viewed from a second view point;

FIG. 6A is a plan view of an exemplary pixel arrangement pattern of a view point image to be viewed from the first view point when a three-dimensional image is displayed for the two view points by the three-dimensional image display apparatus shown in FIG. 1;

FIG. 6B is a plan view of an exemplary pixel arrangement pattern of a view point image to be viewed from the second view point;

FIG. 7 is an illustration showing the principle of three-dimensional image display performed by a three-dimensional image display apparatus according to a second embodiment;

FIG. 8A is a plan view of one pixel of a common image display device according to the related art showing a structure thereof;

FIG. 8B is a plan view of an exemplary pixel arrangement pattern for displaying a three-dimensional image on a three-dimensional image display apparatus according to the related art in the case of nine view points, the illustration showing a one pixel worth of area to be viewed from each view point; and

FIG. 9 is a plan view of a barrier pattern of a parallax device associated with the pixel arrangement pattern shown in FIG. 8B.

### DETAILED DESCRIPTION

Embodiments of the present application will be described below in detail with reference to the drawings.

### First Embodiment

General Configuration of Three-Dimensional Image Display Apparatus

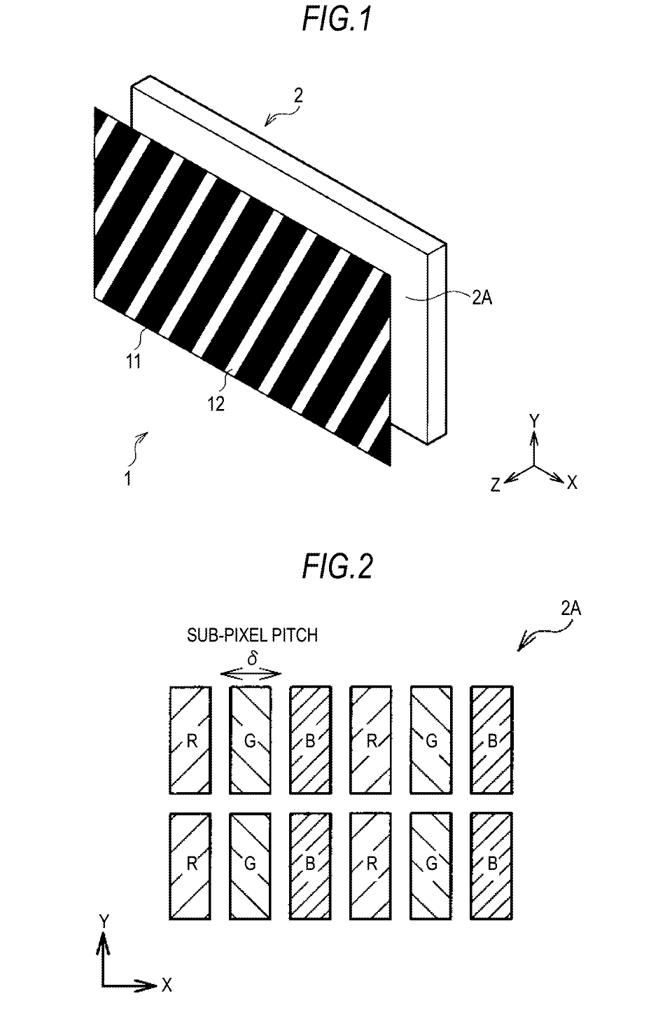

FIG. 1 shows one exemplary configuration of a three-dimensional image display apparatus according to a first embodiment. The three-dimensional image display apparatus includes a parallax barrier 1 as a parallax device and an image display device 2. The parallax barrier 1 includes shield portions 11 and openings 12.

The image display device 2 is constituted by a two-dimensional display such as a liquid crystal display panel, an electroluminescent display panel, or a plasma display. A plurality of pixels are arranged in the horizontal and vertical directions to form a two-dimensional array of pixels on an image display surface 2A of the image display device 2. Each pixel is formed by a plurality of sub-pixels. For example, each pixel is formed by R (red) sub-pixels, G (green) sub-pixels, and B (blue) sub-pixels as shown in FIG. 2. Sub-pixels in the three colors are periodically and alternately arranged to form each row of sub-pixels when viewed in the horizontal direction of the pixel, and sub-pixels having the same color are arranged to form each column of sub-pixels when viewed in the vertical direction of the pixel. Referring to FIG. 2, each elongate rectangle represents one sub-pixel. View point images for a plurality of view points are allocated to the sub-pixels of the image display device 2 according to a predetermined pixel arrangement pattern which will be described later such that the sub-pixel are compositely displayed.

The parallax barrier 1 separates a plurality of view point images included in a composite parallax image displayed on the image display device 2 in the directions of the plurality of view points. The barrier is disposed to face the image display device 2 in a predetermined positional relationship therewith to allow an image to be viewed in a three-dimensional manner. The parallax barrier 1 includes shield portions 11 blocking light and openings 12 transmitting light and serving as parallax separating portions associated with the sub-pixels of the image display device 2 according to predetermined conditions to allow an image to be viewed in a three-dimensional manner. For example, the parallax barrier 1 is formed by providing a black substance transmitting no light or a metal in the form of a thin film reflecting light on a transparent sheet. Alternatively, the parallax barrier 1 may be a variable barrier formed using a liquid crystal display device.

The parallax barrier 1 spatially separates a plurality of view point images included in a composite parallax image on the screen of the image display device 2 such that only a certain view point image is viewed when the image display device 2 is viewed from a certain view point. The exiting angle of light emitted by each sub-pixel of the image display device 2 is limited by the positional relationship between the openings 12 of the parallax barrier 1 and the sub-pixels of the image display device 2. The sub-pixels of the image display device 2 are displayed in different directions depending on the positional relationship between the sub-pixels and the openings 12. Light rays from different sub-pixels reach the left and right eyes of a viewer and are viewed as images which are parallaxed with respect to each other. Thus, the light rays can be perceived as a three-dimensional image.

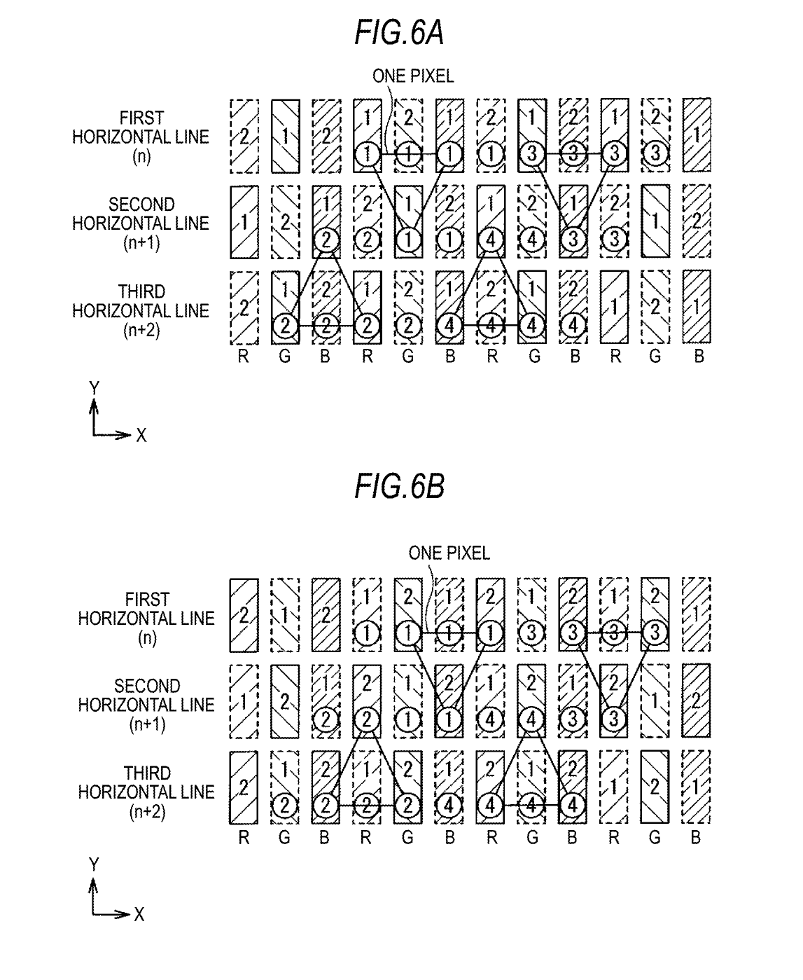

The openings 12 of the parallax barrier 1 are provided in a pattern (barrier pattern) in the form of oblique stripes extending straightly in an oblique direction. The barrier pattern is in accordance with the pixel arrangement pattern for displaying each view point image on the image display device 2. For example, in the case of a pixel arrangement pattern as shown in FIGS. 4B and 6B, openings 12 have a width substantially equal to, for example, a sub-pixel pitch δ of the image display device 2, and each pair of adjoining openings 12 is therefore disposed at a pitch of 26. The width and pitch of the openings 12 have values which are fine-adjusted in consideration to the configuration of the display used as the image display device 2, although the embodiment will not be detailed further from this point of view.

Specific Example of Pixel Arrangement Pattern

A description will now be made on a specific example of the pixel arrangement pattern for displaying each view point image on the image display device 2 of the three-dimensional image display apparatus according to the present embodiment. In the following description, the inherent display resolution of the image display device 2 itself will be referred to as “panel resolution”, and resolution at which each view point image is displayed will be referred to as “3D resolution”.

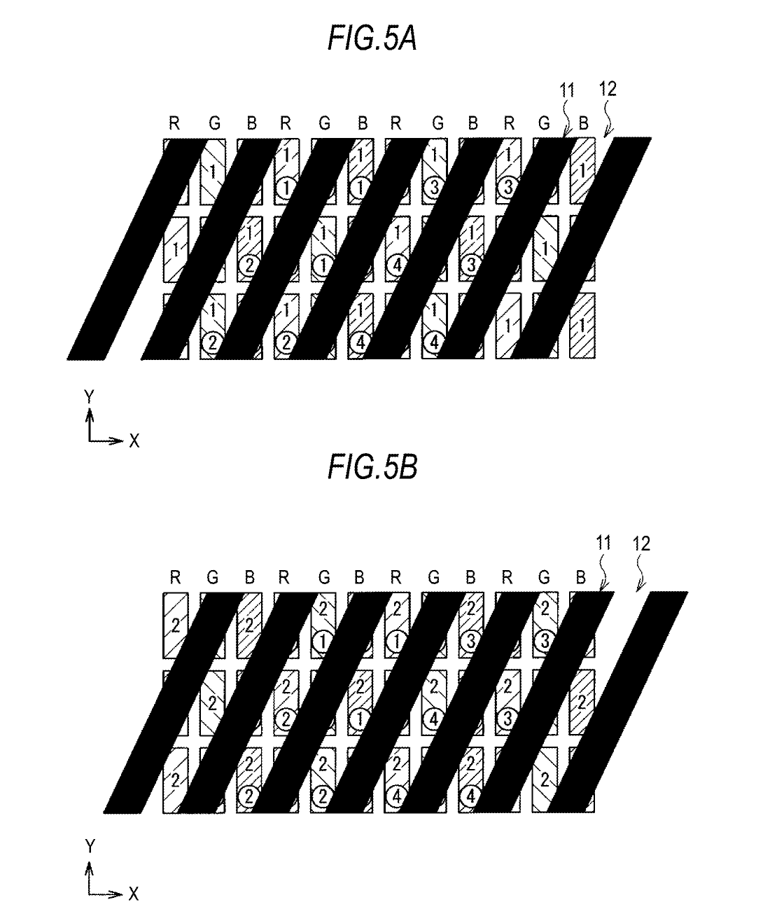

FIG. 4A shows an arrangement of four pixels of the image display device 2 having the inherent display resolution (panel resolution) of the device. FIG. 4B shows an exemplary pixel arrangement pattern for displaying a three-dimensional image on the three-dimensional image display apparatus in the case of two view points, the illustration showing a four pixels worth of area to be viewed from each view point. FIG. 5A shows how pixels are viewed from a first view point through the parallax barrier 1 when a three-dimensional image is to be displayed for the two view points by the three-dimensional image display apparatus. FIG. 5B shows how pixels are viewed from a second view point through the parallax barrier 1. FIG. 6A shows an exemplary pixel arrangement pattern of a view point image to be viewed from the first view point when a three-dimensional image is displayed for the two view points by the three-dimensional image display apparatus. FIG. 6B shows an exemplary pixel arrangement pattern of a view point image to be viewed from the second view point.

Each pixel of the image display device 2 is inherently formed by sub-pixels in three colors (R, G, and B) arranged in the horizontal direction. Each elongate rectangle represents one sub-pixel. Referring to the inherent surface area of each pixel of the image display device 2, the size of the pixel is equivalent to three sub-pixels when viewed in the horizontal direction and equivalent to one sub-pixel when viewed in the vertical direction. In FIGS. 4A to 6B, the circled numbers 1 to 4 are shown to represent sub-pixel combinations each of which constitutes one pixel, and each combination of sub-pixels indicated by the same circled number represents one pixel. In the following description, a pixel indicated by circled 1s is called “a first pixel”; a pixel indicated by circled 2s is called “a second pixel”; a pixel indicated by circled 3s is called “a third pixel”; and a pixel indicated by circled fours is called “a fourth pixel”. In the inherent pixel structure of the image display device 2 shown in FIG. 4A, the surface area of the four pixels, i.e., the first to fourth pixels is a size equivalent to six sub-pixels in the horizontal and equivalent to two sub-pixels in the vertical direction.

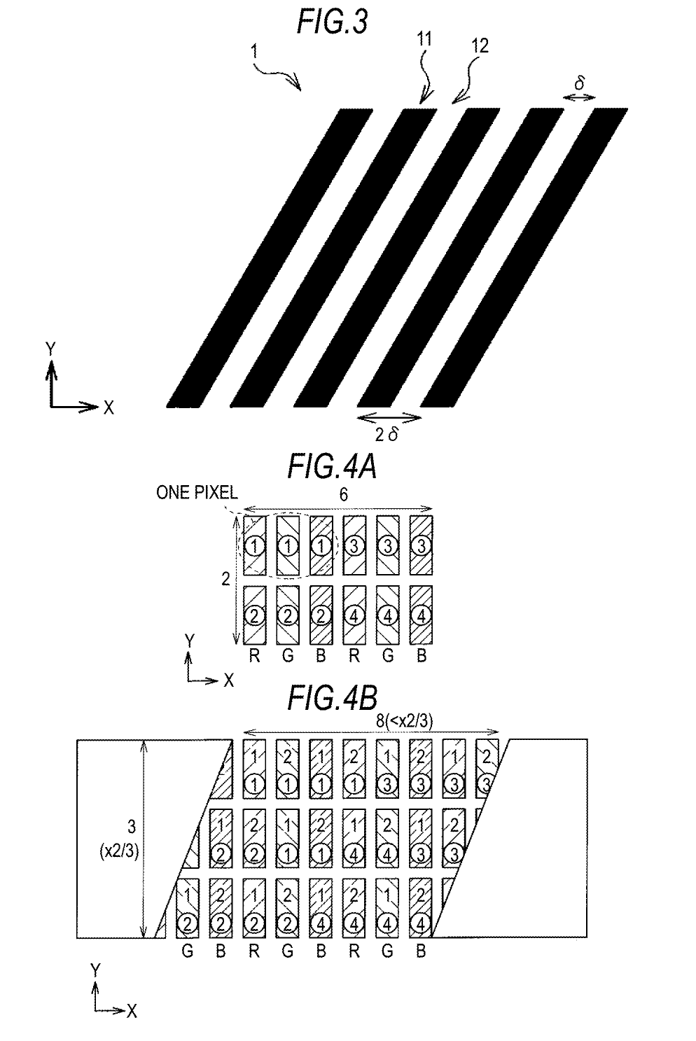

The non-circled numbers assigned to sub-pixels shown in FIGS. 4B, 5A, 5B, 6A, and 6B are numbers representing the view points. Either of two view point numbers, i.e., the number “1” associated with the first view point or the number “2” associated with the second view point is assigned to each sub-pixel. Referring to FIG. 4B, an area that is a size equivalent to eight sub-pixels in the horizontal direction and equivalent to three sub-pixels in the vertical direction is required to display all of the four pixels of each view point image. All of the four pixels to be displayed for the two view points occupy an area which is 3/2 times or 1.5 times greater in the horizontal direction and 8/6 times (which is smaller than 1.5) greater in the vertical direction compared to the inherent surface area occupied by four pixels of the image display device 2 (FIG. 4A). In this case, the openings 12 of the barrier pattern have a width substantially equal to the sub-pixel pitch δ, and each pair of adjoining openings is therefore disposed at a pitch substantially equivalent to 2δ, as shown in FIG. 3. Therefore, in the pixel arrangement pattern shown in FIG. 4B, the display resolution (3D resolution) of each view point image is ⅔ and 6/8 (which is greater than ⅔) of the inherent display resolution (panel resolution) of the image display device 2 itself in the horizontal and vertical directions, respectively. When a full high definition device is used as the image display device 2, the panel resolution and the 3D resolution may be set at 1920×1080 and 1440×720, respectively, where each resolution value is represented by the number of pixels in the horizontal direction multiplied by the number of pixels in the vertical direction.

High definition (HD) resolution is resolution of 1280×720 or higher. Therefore, the use of the pixel arrangement pattern shown in FIG. 4B allows HD three-dimensional resolution to be achieved using an image display device having resolution of 1920×1080.

The pixel arrangement pattern shown in FIG. 4B will now be detailed with reference to FIGS. 6A and 6B. In the present embodiment, each view point image is displayed using a first combination format and a second combination format as formats for combining a plurality of sub-pixels forming each pixel of the image. The formats have shapes which are the inverse of each other when viewed in the vertical direction of the figures. Thus, each view point image is displayed such that a first pixel arrangement pattern formed using the first combination format and a second pixel arrangement pattern formed using the second combination format alternately appear in the vertical direction. Each pixel having the first pixel arrangement pattern is formed as a combination of sub-pixels (or a sub-pixel) on an n-th (n represents 1 or a greater integer) horizontal line of pixels of the image display device 2 and a sub-pixels (or sub-pixels) on the (n+1)-th horizontal line of pixels adjacent to the n-th horizontal line of pixels. Each pixel having the second pixel arrangement pattern is formed as a combination of a sub-pixel (or sub-pixels) on the (n+1)-th horizontal line of pixels and sub-pixels (or a sub-pixel) on the (n+2)-th horizontal line of pixels adjacent to the (n+1)-th horizontal line of pixels.

Referring to the view point image for the first view point shown in FIG. 6A by way of example, the first pixel (the pixel indicated by circled 1s) and the third pixel (the pixel indicated by circled 3s) have a pixel configuration in the first pixel arrangement pattern. The second pixel (the pixel indicated by circled 2s) and the fourth pixel (the pixel indicated by circled 4s) have a pixel configuration in the second pixel arrangement pattern. Each pixel having the first pixel arrangement pattern is formed as a combination of two sub-pixels on an n-th horizontal line of pixels (e.g., the first horizontal line) and one sub-pixel on the (n+1)-th horizontal line of pixels (e.g., the second horizontal line). Thus, the pixel is formed in a first combination format which is an inverted triangle (a downward convex). Each pixel having the second pixel arrangement pattern is formed as a combination of one sub-pixel on the (n+1)-th horizontal line of pixels (e.g., the second horizontal line) and two sub-pixels on the (n+2)-th horizontal line of pixels (e.g., the third horizontal line). Thus, the pixel is formed in a second combination format which is a triangle (an upward convex). As a result, pixels (e.g., the first and second pixels) are arranged in the vertical direction in the form of a combination of the inverted triangular shape (the downward convex) and the triangular shape (the upward convex). As thus described, pixels formed in the first combination format and the second combination format having shapes which are the inverse of each other when viewed in the vertical direction appear on the screen such that the formats alternate in the vertical direction.

A pixel having the first pixel arrangement pattern and a pixel having the second pixel arrangement pattern are partially formed by sub-pixels located on the same horizontal lie. For example, in the example shown in FIG. 6A, sub-pixels located on the (n+1)-th horizontal line are included in both of a pixel (e.g., the first pixel) having the first pixel arrangement pattern and a pixel (e.g., the second pixel) having the second pixel arrangement pattern. Since the device has a structure in which two pixels adjoining each other in the vertical direction include sub-pixels located on a common horizontal line of pixels as thus described, degradation of the resolution of pixels in the vertical direction can be suppressed.

The view point image for the second view point shown in FIG. 6B also has pixel arrangement patterns substantially similar to those described above except that the pixel positions of the image is shifted in the horizontal direction from those of the view point image for the first view point show in FIG. 6A by an amount equivalent to one sub-pixel.

Comparison with Pixel Arrangement Patterns in the Related Art

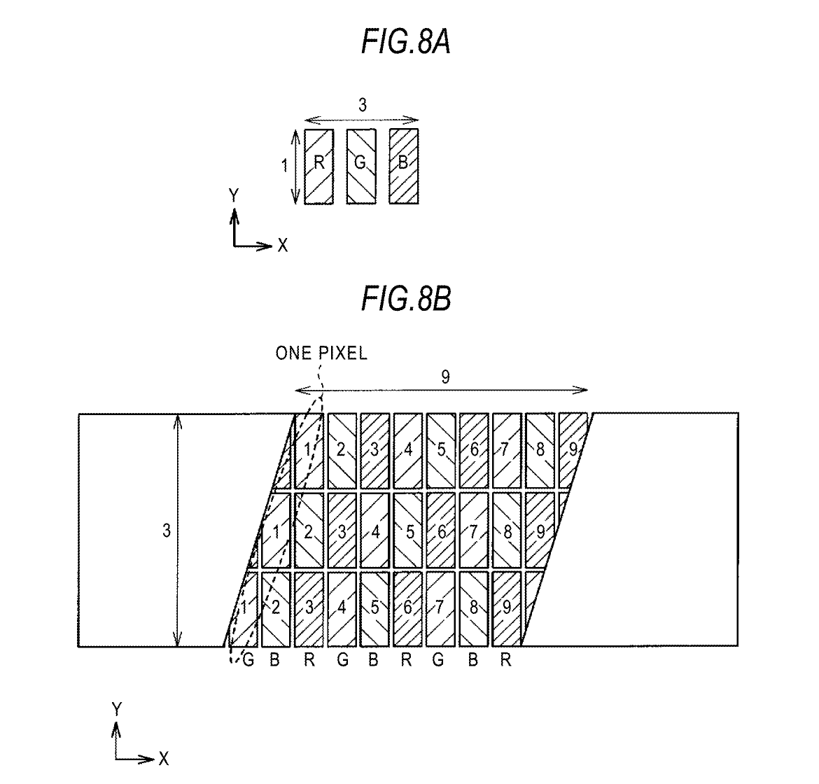

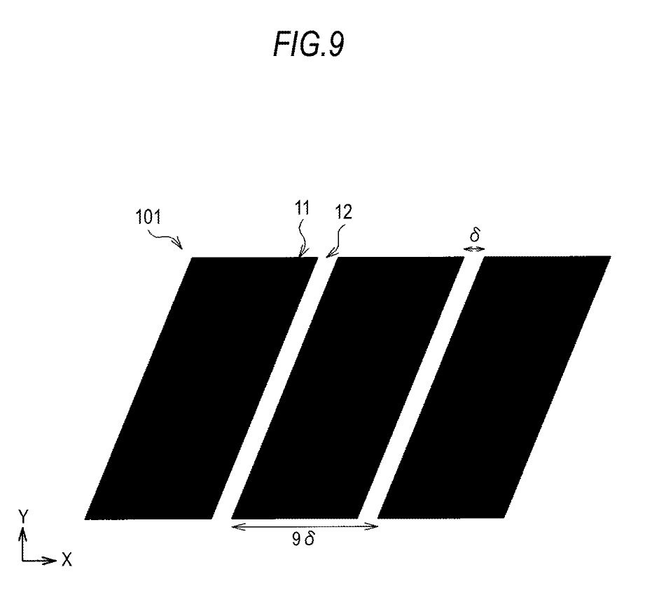

A pixel arrangement pattern will now be described with reference to FIGS. 8A and 8B as an example to be compared with the pixel arrangement pattern of the present embodiment. FIG. 9 shows a barrier pattern of a parallax device 101 associated with the pixel arrangement pattern shown in FIG. 8B. The structure of an image display device as a comparative example is the same as the structure of the image display device 2 of the embodiment. As shown in FIG. 8A, each pixel of the image display device 2 is inherently formed by sub-pixels in three colors (R, G, and B) arranged in the horizontal direction. Referring to FIGS. 8A and 8B, each elongate rectangle represents one sub-pixel. Referring to the inherent surface area of each pixel of the image display device 2, the size of the pixel is equivalent to three sub-pixels in the horizontal direction and equivalent to one sub-pixel in the vertical direction.

Referring to FIG. 8B, the numbers shown in sub-pixels are numbers assigned to view points. FIG. 8B shows an example of a pixel arrangement pattern associated with nine view points, and any of nine numbers 1 to 9 associated with the nine view points is assigned to each sub-pixel. As shown in FIG. 8B, each pixel of each view point image is displayed as a combination of three sub-pixels which are consecutively arranged in an oblique direction. Therefore, an area that is a size equivalent to nine sub-pixels in the horizontal direction and equivalent to three sub-pixels in the vertical direction is required to display one pixel each for all of the nine view points, as illustrated. The area required to display one pixel each for all of the nine view points is equivalent to the area occupied by the image display device 2 to display three pixels each in the horizontal and vertical directions in its original pixel format. In this case, the barrier pattern includes openings 12 having a width substantially equivalent to a sub-pitch pitch δ, and each pair of adjoining openings 12 are disposed at a pitch substantially equivalent to 96, as shown in FIG. 9. Therefore, in the pixel arrangement pattern of this comparative example, the display resolution (3D resolution) of each view point image is ⅓ of the inherent display resolution (panel resolution) of the image display device 2 itself in both of the horizontal and vertical directions. When a full high definition device is used as the image display device 2, the panel resolution and the 3D resolution may be set at 1920×1080×and 640×360, respectively, where each resolution value is represented by the number of pixels in the horizontal direction multiplied by the number of the number of pixels in the vertical direction.

When a device having a common pixel structure in which red, green, and blue sub-pixels are arranged in the horizontal direction as shown in FIG. 8A is used as the image display device 2, the 3D resolution in the vertical direction divided by the panel resolution in the vertical direction is smaller than ½ according to the method employing a barrier pattern in the form of oblique stripes in the related art. It has not been possible according to the related art to obtain vertical 3D resolution higher than one half of the vertical panel resolution. On the contrary, the vertical 3D resolution of the three-dimensional display apparatus according to the present embodiment can be made greater than one half of the vertical panel resolution by displaying view point images using pixel arrangement patterns as shown in FIGS. 6A and 6B.

As described above, the three-dimensional display apparatus according to the present embodiment employs the first combination format and the second combination format which are the inverse of each other when viewed in the vertical direction. Each view point image is displayed such that the first pixel arrangement pattern and the second pixel arrangement pattern formed using those combination formats alternately appear when viewed in the vertical direction. Thus, a three-dimensional image can be displayed at resolution higher than that in the related art. In particular, degradation of resolution in the vertical direction can be kept less signification compared to degradation encountered when an oblique stripe pattern or oblique stepwise pattern according to the related art is used. A three-dimensional image can be displayed at resolution higher than that in the related art using an image display device 2 having a common pixel arrangement which has existed in the related art.

### Second Embodiment

A three-dimensional display apparatus according to a second embodiment will now be described. Elements which are substantially identical between the present embodiment and the above-described first embodiment are indicated by common reference numerals, and description may be omitted for such elements as occasion demands.

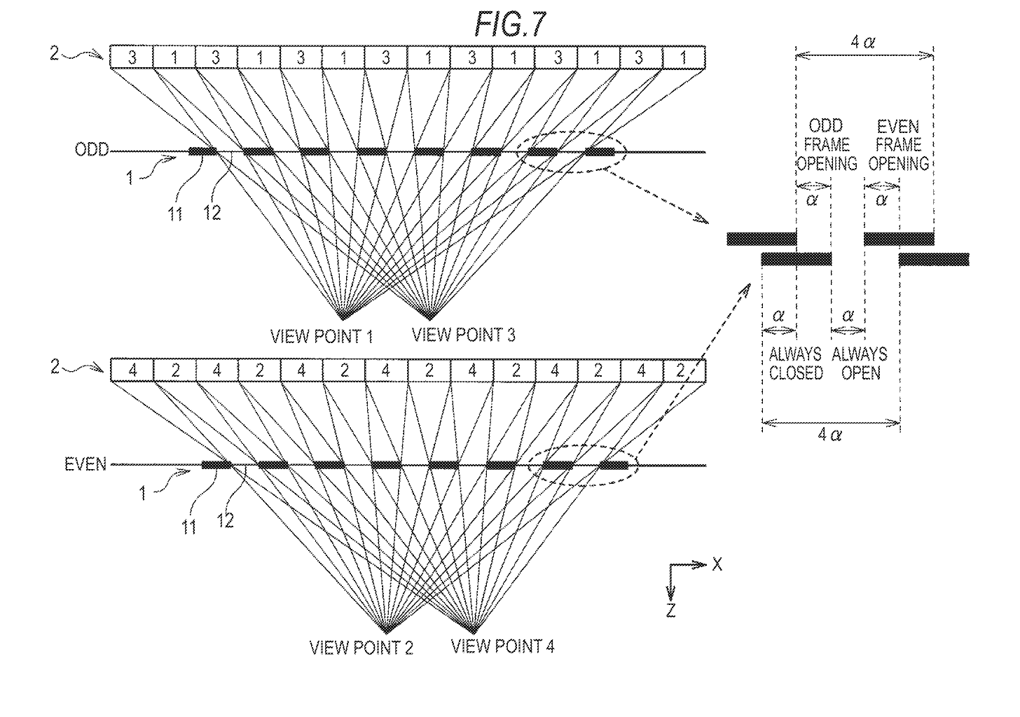

FIG. 7 shows the principle of three-dimensional image display performed by the three-dimensional image display apparatus according to the present embodiment. In the three-dimensional image display apparatus of the present embodiment, an image display device 2 displays a plurality of view point images on a time-division basis as two types of frames, i.e., a series of first frames (e.g., odd-numbered frames) and a series of second frames (e.g., even-numbered frames). A parallax barrier 1 changes the position of openings 12 (barrier pattern) in synchronism with timing at which the display of the view point images is switched on a time-division basis. View point images of each frame displayed on the image display device 2 can be properly spatially separated in respective viewing directions associated with the view point images to provide a three-dimensional view of the images by changing the barrier pattern in synchronism with the timing at which the display of the images is switched on a time-division basis. In order to exercise such control, for example, a variable barrier employing a liquid crystal display device may be used as the parallax barrier 1.

FIG. 7 shows an example of an operation of displaying view point images for four view points in total using first and second frames. Let us assume that viewing positions to provide a three-dimensional view of an image in this example are a first view point, a second view point, a third view point, and a fourth view point which are listed in the left-to-right horizontal direction. Referring to FIG. 7, four numbers 1 to 4 are assigned to various parts of the image display device 2. Each number is a number assigned to a view point. For example, a view point image for the first view point is displayed at the parts to which the number “1” is assigned. In the example shown in FIG. 7, a view point image for the first view point and a view point image for the third view point are displayed in the first frames. A view point image for the second view point and a view point image for the fourth view point are displayed in the second frames.

An example of control exercised on the barrier pattern of the parallax barrier 1 is shown on the right side of FIG. 7. The barrier pattern includes parts which always serve as shield portions 11 in the first and second frames and parts which always serve as openings 11 in those frames. The barrier pattern also includes parts which serve as openings 12 only in the first frames and parts which serve as openings 12 only in the second frames. Those portions have an equal width a in the horizontal direction. Each frame has a barrier pitch (the pitch of openings 12) which is substantially equivalent to 4α when it is assumed that the portions of the device have the equal width α in the horizontal direction. A device having shields and openings which can be switched using the width α as the unit of changes may be used as the parallax barrier 1. The width and pitch of the openings 12 may be values fine-adjusted taking the configuration and the like of the display used as the image display device 2 into consideration, and detail description is omitted in this embodiment.

When an image is displayed on a time-division basis as thus described, a greater number of view points can be provided without degrading 3D resolution. In the example shown in FIG. 7, view point images for four view points are displayed in total, and view point images for two view points are displayed in each series of frames. Therefore, the pixel arrangement pattern of each view point image displayed on the image display device 2 in each series of frames may be similar to the pixel arrangement pattern as shown in FIGS. 4A to 6B. That is, a three-dimensional image from four view points in total can be displayed at the same 3D resolution at which a three-dimensional image from two view points is displayed. When a full HD device is used as the image display device 2, the panel resolution and the 3D resolution can be set at the same values 1920×1080 and 1440×720, respectively, as in the case of two view points where each resolution value is represented by the number of pixels in the horizontal direction multiplied by the number of the number of pixels in the vertical direction.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

1. An image display apparatus comprising:
an image display device having a two-dimensional array of pixels each formed by a plurality of sub-pixels and displaying a plurality of view point images in a composite manner by allocating the images to the sub-pixels; and
a parallax device spatially separating the view point images displayed on the image display device, wherein the image display device displays each view point image using a first combination format and a second combination format as formats for combining a plurality of sub-pixels for forming each pixel, the combination formats having shapes which are the inverse of each other when viewed in the vertical direction, the image being displayed such that a first pixel arrangement pattern formed using the first combination format and a second pixel arrangement pattern formed using the second combination format alternately appear in the vertical direction.

2. An image display apparatus according to claim 1,
wherein each pixel having the first pixel arrangement pattern is formed as a combination of a sub-pixel on an n-th (n represents 1 or a greater integer) horizontal line of pixels of the image display device and a sub-pixel on the (n+1)-th horizontal line of pixels adjacent to the n-th horizontal line of pixels; and
each pixel having the second pixel arrangement pattern is formed as a combination of a sub-pixel on the (n+1)-th horizontal line of pixels and a sub-pixel on the (n+2)-th horizontal line of pixels adjacent to the (n+1)-th horizontal line of pixels.

3. An image display apparatus according to claim 2,
wherein each pixel having the first pixel arrangement pattern is formed as a combination of two sub-pixels on the n-th horizontal line of pixels and one sub-pixel on the (n+1)-th horizontal line of pixels; and
each pixel having the second pixel arrangement pattern is formed as a combination of one sub-pixel on the (n+1)-th horizontal line of pixels and two sub-pixels on the (n+2)-th horizontal line of pixels.

4. An image display apparatus according to claim 1,
wherein the first combination format is in the form of an inverted triangle and the second combination format is in the form of a triangle.

5. An image display apparatus according to claim 1,
wherein sub-pixels in the same color are arranged in the vertical direction of the image display device and sub-pixels in three different colors are periodically and alternately arranged in the horizontal direction.

6. An image display apparatus according to claim 1,
wherein the view point images are displayed at display resolution in the vertical direction which is greater than one half of display resolution of the image display device itself in the vertical direction.

7. An image display apparatus according to claim 1,
wherein the parallax device is a parallax barrier having a plurality of openings transmitting light and a shield portion blocking light; and
the openings are in the form of oblique stripes.

8. An image display apparatus according to claim 7,
wherein the image display device displays a plurality of the view point images in a first frame and a second frame on a time-division basis; and
the parallax device changes the position of the openings in synchronism with timing at which display of the view point images is switched on a time-division basis.

9. An image display apparatus according to claim 8,
wherein the image display device displays two or more view point images among the plurality of view point images in the first frame and displays other two or more view point images among the plurality of view point images in the second frame; and
the parallax device changes the position of the openings such that the view point images are spatially separated in each of the frames.

10. An image display apparatus comprising:
an image display device displaying a plurality of view point images; and
a parallax device spatially separating the view point images formed on the image display device,
the image display device displaying the view point images using a first pixel arrangement pattern and a second pixel arrangement pattern,
each pixel having the first pixel arrangement pattern being formed as a combination of two sub-pixels on the n-th horizontal line of pixels and one sub-pixel on the (n+1)-th horizontal line of pixels,
each pixel having the second pixel arrangement pattern being formed as a combination of one sub-pixel on the (n+1)-th horizontal line of pixels and two sub-pixels on the (n+2)-th horizontal line of pixels.

11. An image display apparatus according to claim 10,
wherein sub-pixels in the same color are arranged in the vertical direction of the image display device and sub-pixels in three different colors are periodically and alternately arranged in the horizontal direction.

12. An image display apparatus according to claim 10,
wherein the view point images are displayed at display resolution in the vertical direction which is greater than one half of display resolution of the image display device itself in the vertical direction.

13. An image display apparatus according to claim 10,
wherein the parallax device is a parallax barrier having a plurality of openings transmitting light and a shield portion blocking light; and
the openings are in the form of oblique stripes.

14. An image display apparatus according to claim 13,
wherein the image display device displays a plurality of the view point images in a first frame and a second frame on a time-division basis; and
the parallax device changes the position of the openings in synchronism with timing at which display of the view point images is switched on a time-division basis.

15. An image display apparatus according to claim 14,
wherein the image display device displays two or more view point images among the plurality of view point images in the first frame and displays other two or more view point images among the plurality of view point images in the second frame; and
the parallax device changes the position of the openings such that the view point images are spatially separated in each of the frames.
